(19) United States
(12) Patent Application Publication
(10) Pub. No.: US 2012/0134254 A1
(43) Pub. Date: May 31, 2012

(54) OPTICAL PICKUP APPARATUS

(75) Inventor: Minoru SATO, Ota-city (JP)

(73) Assignee: SANYO ELECTRIC CO., LTD, Moriguchi-city (JP)

(21) Appl. No.: 13/303,897

(22) Filed: Nov. 23, 2011

(30) Foreign Application Priority Data
Nov. 26, 2010 (JP) 2010-263227

(51) Int. Cl. G11B 7/1374; G11B 7/1395; G11B 7/1376

(52) U.S. Cl. 369/112.16; 369/112.23; G9B/7.121; G9B/7.122; G9B/7.132

(57) ABSTRACT

Provided is an optical pickup apparatus that stably operates by accurately detecting a fluctuation in a light amount of a laser beam caused by movement of a collimating lens. In an optical pickup apparatus of the present invention, part of a laser beam emitted from a laser device is transmitted through a reflective mirror and detected by a laser beam FMD. An output of the laser device is adjusted based on the output from the FMD. Even when a collimating lens moves during the operation of the apparatus, the change in the light amount of the laser beam caused by the movement is immediately detected by the FMD and the output of the laser device is adjusted. Thus, the light amount of the laser beam radiated on an optical information recording medium is kept constant along a time axis. Accordingly, the optical pickup apparatus can stably perform reading and writing.

This application claims priority from Japanese Patent Application Number JP 2010-263227 filed on Nov. 26, 2010, the content of which is incorporated herein by reference in its entirety

### BACKGROUND OF THE INVENTION

1. Field of the Invention

The present invention relates to an optical pickup apparatus that performs reproduction or recording of an optical information recording medium by using a laser beam.

2. Description of the Related Art

A structure described in Japanese Patent Application Publication 2008-117499 is known as an embodiment of a conventional optical pickup apparatus. FIG. 3 is a view of some parts of an optical pickup apparatus 100 described in Japanese Patent Application Publication 2008-117499.

The optical pickup apparatus 100 includes: a laser device 102 that emits a laser beam with a predetermined wavelength; a composite prism 104 having a reflective surface that reflects the emitted laser beam in a +X direction; a collimating lens 103 that collimates the reflected beam; a reflecting mirror 105 that reflects the laser beam coming from the +X direction to a +Y direction; an objective lens 106 that focuses the laser beam on an information recording surface of a disc 107; an anamorphic lens 108 that gives astigmatism to the laser beam reflected on the disc 107; a PDIC 109 that receives the laser beam and outputs an information signal and a signal for servo control; and a front monitor diode (FMD) 110 that receives the laser beam emitted from the laser device 102 and outputs a signal for controlling an output of the laser device 102.

The optical pickup apparatus 100 having the structure reads or writes information from or to the disc 107 in the following manner. First, the laser device 102 emits a laser beam with a predetermined wavelength. For example, the laser beam of a Blu-ray disc (BD), digital versatile disc (DVD), or a compact disc (CD) standard is emitted. The emitted laser beam is a beam linearly-polarized in an S direction, for example.

Then, the laser beam is reflected in the +X direction in the drawing by the composite prism 104, collimated by the collimating lens 103, reflected in the +Y direction by the reflecting mirror 105, and focused on the information recording surface of the disc 107 by the objective lens 106.

The laser beam as a returning beam reflected by the disc 107 passes through the objective lens 106, the reflecting mirror 105, and the collimating lens 103 to reach the composite prism 104. Through this process, the laser beam linearly-polarized in the S direction is converted into a beam linearly-polarized in a P direction by a quarter wavelength plate not shown. The laser beam linearly-polarized in the P direction passes through a polarization selective reflective film of the composite prism 104, is given astigmatism by the anamorphic lens 108, and then is radiated on the PDIC 109. The PDIC 109 outputs a signal of the read information and a signal for servo control.

While the optical pickup apparatus 100 is operating, the laser beam emitted from the laser device 102 partly passes through the reflective surface of the composite prism 104 and is radiated on the FMD 110. The FMD 110 outputs a signal corresponding to the light amount of the radiated laser beam. The laser beam to be emitted from the laser device 102 is adjusted based on this output signal.

### SUMMARY OF THE INVENTION

Unfortunately, there is a problem that the optical pickup apparatus 100 with the structure cannot accurately control the laser device 102 on the basis of the output signal from the FMD 110.

Specifically, the collimating lens 103 moves along an optical path during operation of the optical pickup apparatus 100. This movement is for optimizing spherical aberration to prevent the generation of inter layer stray beam and interlayer crosstalk. The movement of the collimating lens 103 changes the light amount of the laser beam transmitted through the collimating lens 103. As found from a comparison between the collimated lenses 103 disposed on the right and left sides in FIG. 3 in terms of the transmitted light amount, the collimating lens 103 on the right side transmits a larger amount of light than the collimating lens 103 on the left side.

The FMD 110 that detects the light amount of the laser beam detects the laser beam before passing through the collimating lens 103 and cannot detect the change in the laser beam due to the movement of the collimating lens 103.

Thus, the light amount of the laser beam reaching the disc 107 fluctuates due to the fluctuation of the light amount of the laser beam caused by the movement of the collimating lens 103 so that there arises a problem of unstable operation of the optical pickup apparatus 100.

The present invention is made in view of the above problem and an object of the present invention is to provide an optical pickup apparatus that stably operates by accurately detecting the fluctuation in the light amount of the laser beam caused by the movement of the collimating lens.

An optical pickup apparatus according to the present invention includes an emitting element that emits a laser beam; a collimating lens that is disposed to be movable along an optical path of the laser beam and collimates the laser beam; an objective lens that focuses the laser beam on an information recording layer of an optical information recording medium; a branching element that is disposed on the optical path between the collimating lens and the objective lens and branches off part of the laser beam from the optical path; and a detecting element that receives the part of the laser beam branched off from the optical path and outputs a control signal for controlling a light amount of the laser beam emitted from the emitting element.

### BRIEF DESCRIPTION OF THE DRAWINGS

FIG. 1 is a diagram illustrating an optical system of an optical pickup apparatus according to a preferred embodiment of the present invention.

FIGS. 2A and 2B are diagrams each partially showing the optical pickup apparatus according to a preferred embodiment of the present invention, and FIG. 2C is a chart illustrating a property of a reflective film of composite prisms and a reflective mirror.

FIG. 3 is a schematic view illustrating an optical system of a conventional optical pickup apparatus.

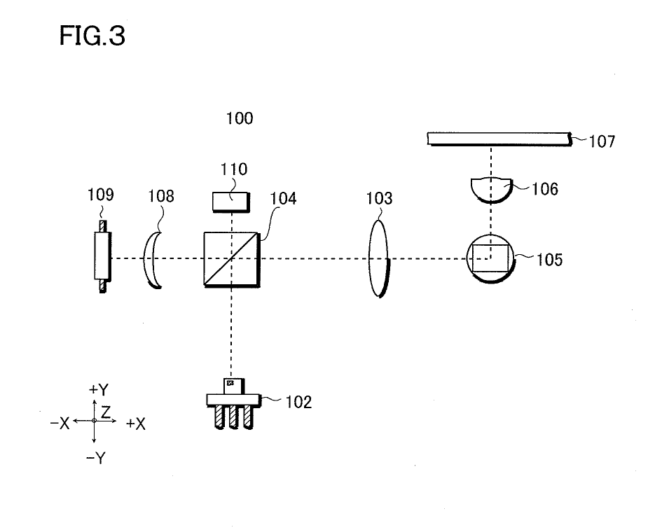

### DESCRIPTION OF THE INVENTION

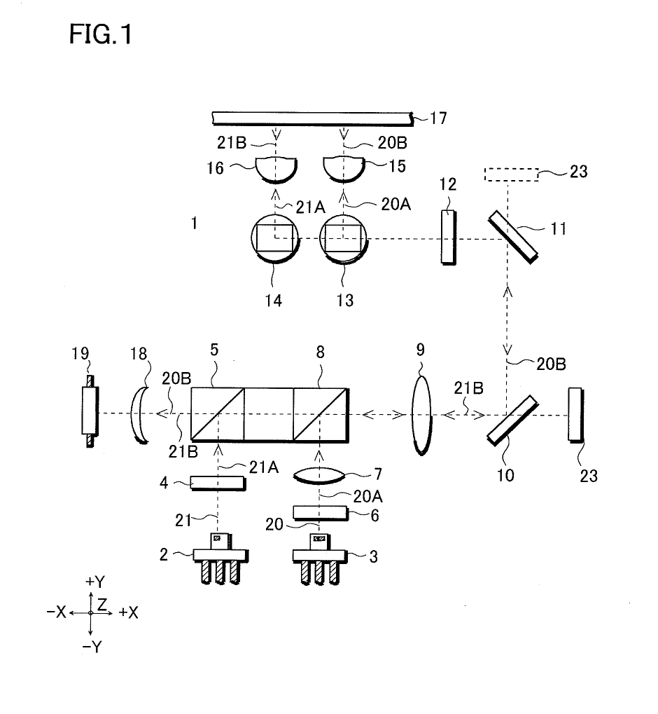

Referring to FIG. 1, an optical pickup apparatus 1 has functions of focusing a laser beam of a BD, DVD, or CD standard on an information recording layer of an optical information recording medium 17 (optical disc) and converting a reflected laser beam received from the information recording layer into an electrical signal. In this manner, the optical pickup apparatus 1 reads or writes information from or to the optical information recording medium 17.

A laser device 2 (emitting element) emits a laser beam with a wavelength (in a blue-violet (blue) wavelength range 400 nm to 420 nm (e.g., 405)) of the BD standard. A laser device 3 emits a laser beam with a wavelength (in a red wavelength range 645 nm to 675 nm (e.g., 655 nm)) of the DVD standard and a laser beam with a wavelength (in an infrared wavelength range 765 nm to 805 nm (e.g., 785 nm)) of the CD standard. The semiconductor laser devices 2 and 3 may each be a CAN type package or a lead frame package.

A diffraction grating 4 on which the laser beam of the BD standard is made incident is disposed between the laser device 2 and a composite prism 5. The diffraction grating 4 includes a diffraction grating that separates the incident laser beam into 0th order light, +1st order diffracted light, and −1st order diffracted light and a half wavelength plate that converts the incident laser beam into a beam linearly-polarized in an S direction with respect to a polarization surface of the composite prism 5. Similarly, a diffraction grating 6 is disposed between the laser device 3 and a composite prism 8 and includes a diffraction grating and a half wavelength plate. The diffraction grating 6 converts the incident laser beam of the DVD/CD standard into the beam linearly-polarized in the S direction with respect to a polarization surface of the composite prism 8.

A divergent lens 7 is disposed between the diffraction grating 6 and the composite prism 8 and adjusts the spread angle of the laser beam diffracted by the diffraction grating 6. The composite prism 5 (polarized beam splitting element) incorporates a polarization surface having a wavelength selectivity and a polarization selectivity to serve as a polarized beam splitter for the laser beam of the BD standard and as a total transmission prism for the laser beam of the DVD/CD standard. Specifically, the laser beam of the BD standard as the beam linearly-polarized in the S direction is reflected in the +X direction in the drawing by the polarization surface of the composite prism 5. The laser beam (returning beam) reflected by the optical information recording medium 17 is a beam linearly-polarized in the P direction and thus passes through the polarization surface in the −X direction in the drawing.

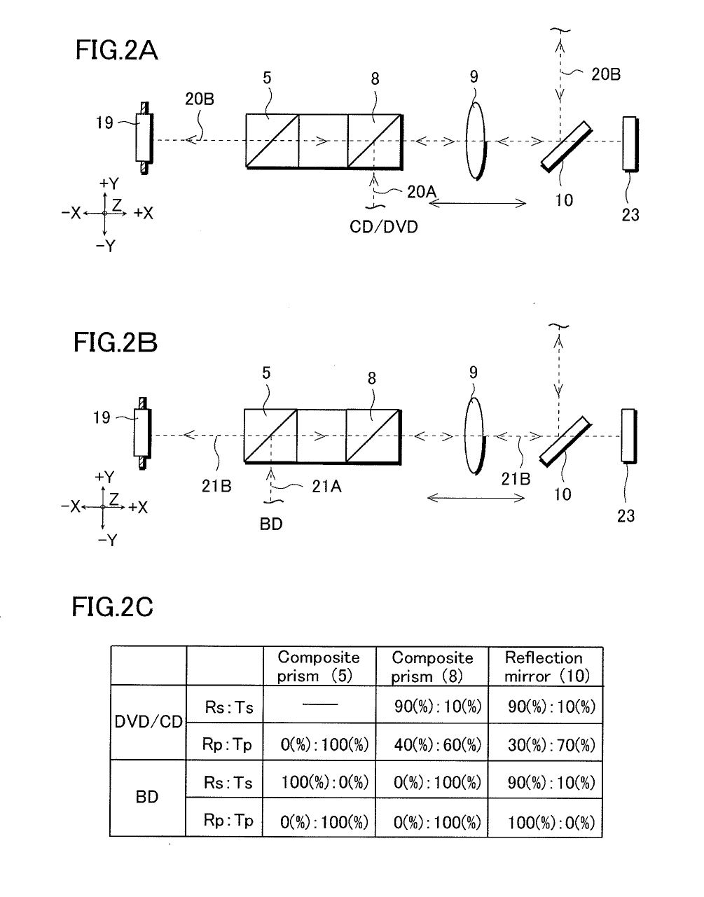

The composite prism 8 incorporates a polarization surface having a wavelength selectivity and a polarization selectivity and serves as a polarized beam splitter for the laser beam of the DVD/CD standard and as a total transmission prism for the laser beam of the BD standard. Specifically, the composite prism 8 adjusts the reflectance of the laser beam of the DVD/CD standard to adjust the light amount of a second laser beam guided to the photodetector (PDIC) 19. The laser beam of the DVD/CD standard as the beam linearly-polarized in the S direction is mostly reflected in the +X direction in the drawing by the polarization surface of the composite prism 8. Meanwhile, the laser beam (returning beam) of the DVD/CD standard reflected by the optical disc is the beam linearly-polarized in the P direction and certain percentage thereof passes through the polarization surface in the −X direction in the drawing. The adjustment of the light amount of the laser beam of the DVD/CD standard with the composite prism 8 is described later with reference to FIG. 2.

A collimating lens 9 converts each of the laser beams of the BD, DVD, and CD standards into a substantially parallel beam (including weak finite light generated by the displacement of the collimating lens 9 in a direction of an optical axis as well as infinite light). As shown in the drawing, the collimating lens 9 moves in parallel (±X direction in the drawing) with an optical path (optical axis) represented by a dotted line to change a divergence angle or a convergence angle of the laser beam transmitted through the collimating lens 9. The collimating lens 9 optimizes the spherical aberration for each of the laser beams of the standards to prevent the generation of interlayer stray beam and interlayer crosstalk.

This movement of the collimating lens 9 during the operation of the apparatus changes the light amount of the laser beam transmitted through the collimating lens 9. Without any countermeasure against the change in the amount of the laser beam, the problem described above arises. Thus, in this embodiment, the laser beam transmitted through the collimating lens 9 is detected by an FMD 23 (detecting element) to adjust the laser beam. This will be described later by referring to FIG. 2.

The reflective mirror 10 has a wavelength selectivity and a polarization selectivity. Specifically, the reflective mirror 10 transmits part of the laser beam in an outward path to be radiated on the FMD 23. The reflective mirror 10 partly transmits (leaks) the laser beam in the return path to adjust the light amount of the laser beam reaching a PDIC 19.

The FMD 23 receives the laser beam in the outward path transmitted through the reflective mirror 10 and outputs a signal indicating a light amount of the received laser beam. The laser devices 2 and 3 are controlled on the basis of the output of the FMD 23. The specific operations and effects of the FMD 23 are described later by referring to FIG. 2.

The reflective mirror 11 totally reflects in the −X direction in the drawing, each of the laser beams of the standards in the outward path. Similarly, the reflective mirror 11 totally reflects in the −Y direction in the drawing, the laser beam (returning beam) in the return path reflected by the optical information recording medium 17.

The reflective mirrors 10 and 11 may exchange functions. In such a case, the reflective mirror 10 totally reflects the laser beam. Meanwhile, part of the laser beam in the outward path made incident on the reflective mirror 11 passes through the reflective mirror 11 to be radiated on the FMD 23 illustrated in a dotted line. Thus, in this case, the light amount of the laser beam in the return path guided to the PDIC 19 is adjusted by adjusting the transmittance and reflectance of the composite prism 8 and the reflective mirror 11.

A quarter wavelength plate 12 generates phase difference in an incident laser beam to convert each of the laser beams of the standards as the beam linearly-polarized in the S direction into a circularly-polarized beam. The laser beam (returning beam) reflected by the optical information recording medium 17 is converted into the beam linearly-polarized in the P direction by again passing through the quarter wavelength plate 12.

A reflecting mirror 13 includes a reflection surface having a frequency selectivity and thus reflects the laser beam of the DVD/CD standard in the +Y direction in the drawing, and transmits the laser beam of the BD standard in the −X direction in the drawing. A reflecting mirror 14 reflects in the +Y direction in the drawing, the laser beam of the BD standard transmitted through the reflecting mirror 13.

An objective lens 15 focuses the laser beam of the DVD/CD standard reflected by the reflecting mirror 13 on the information recording layer of the optical information recording medium 17. Similarly, an objective lens 16 focuses the laser beam of the BD standard reflected by the reflecting mirror 14 on the information recording layer of the optical information recording medium 17.

An anamorphic lens 18 is disposed between the composite prism 5 and the PDIC 19 and transmits each of the laser beams (returning beams) of the standards reflected by the optical information recording medium 17. The anamorphic lens 18 gives astigmatism for focus servo to the transmitting laser beam, and thus serves as a sensor lens allowing the laser beams of the standards to be processed by a single PDIC 19.

The PDIC 19 functions as a photodetector and incorporates a photodiode integrated circuit element for signal detection. The PDIC 19 receives the laser beams of the standards on a beam receiving region of a single plane and performs photoelectric conversion to output a detection signal including information signal components. The PDIC 19 also outputs a detection signal including a servo signal component used for focus servo and tracking servo.

Optical paths 20 of the laser beam of the DVD/CD standard will be described.

The laser beam emitted from the laser device 3 is converted into the beam linearly-polarized in the S direction by the diffraction grating 6, adjusted to have a predetermined wide angle by the divergent lens 7, and then is made incident on the composite prism 8. The laser beam is reflected by the polarization surface of the composite prism 8, converted into the parallel beam by the collimating lens 9, and then is reflected by the reflective mirror 10. Part of the laser beam converted into the parallel beam by the collimating lens 9 passes through the reflective mirror 10 to be radiated on the FMD 23. The output of the laser device 3 is controlled on the basis of the output of the FMD 23.

The laser beam reflected by the reflective mirror 10 is totally reflected by the reflective mirror 11 and passes through the quarter wavelength plate 12. In this process, the beam linearly-polarized in the S direction is converted into the circularly-polarized beam. The circularly-polarized beam is reflected by the reflecting mirror 13 to be focused on the information storage layer of the optical information recording medium 17 by the objective lens 15. This optical path is an outward path 20A of the laser beam of the DVD/CD standard.

The laser beam (returning beam) reflected by the information recording layer of the optical information recording medium 17 passes through the objective lens 15, and is reflected by the reflecting mirror 13. Then, the circularly-polarized beam passes through the quarter wavelength plate 12 to be converted into the beam linearly-polarized in the P direction. Subsequently, the laser beam is reflected by the reflective mirrors 10 and 11, and then passes through the collimating lens 9 and the composite prisms 8 and 5. Then, the laser beam is given astigmatism by the anamorphic lens 18, and received by the light receiving region of the PDIC 19 to be converted into a detection signal through photoelectric conversion. This optical path is a return path 20B of the laser beam of the DVD/CD standard.

In this embodiment, the light amount of the laser beam of the DVD/CD standard in the return path reaching the PDIC 19 is adjusted by adjusting the transmittance and the reflectance of the reflective mirror 10 and the composite prism 8. This will be described later with reference to FIG. 2.

Optical paths 21 of the laser beam of the BD standard will be described. The laser beam emitted from the laser device 2 is first converted into the beam linearly-polarized in the S direction by the diffraction grating 4 and then is made incident on the composite prism 5. Subsequently, the laser beam is totally reflected by the polarization surface of the composite prism 5 and then totally passes through the composite prism 8. Thereafter, the laser beam is converted into the parallel beam in the collimating lens 9, and then have the most part reflected by the reflective mirror 10 and have the remaining part transmitted through the reflective mirror 10. The transmitted laser beam is detected by the FMC 23. The output of the laser device 2 is adjusted on the basis of the output of the FMD 23 as described above.

The laser beam reflected by the reflective mirror 10 is totally reflected by the reflective mirror 11. Then, the beam linearly-polarized in the S direction passes through the quarter wavelength plate 12 to be converted into the circularly-polarized beam. The circularly-polarized beam passes through the reflecting mirror 13, is reflected by the reflecting mirror 14, and then focused on the information recording layer of the optical information recording medium 17 by the objective lens 16. This optical path is an outward path 21A of the laser beam of the BD standard.

The laser beam (returning beam) reflected by the information recording layer of the optical information recording medium 17 passes through the objective lens 16, is reflected by the reflecting mirror 14, and passes through the reflecting mirror 13. Then, the circularly-polarized beam passes through the quarter wavelength plate 12 to be converted into the beam linearly-polarized in the P direction. Then, the laser beam is reflected by the reflective mirrors 10 and 11, and then passes through the collimating lens 9 and the composite prisms 8 and 5. Subsequently, the laser beam is given astigmatism by the anamorphic lens 18 and received by the light receiving region of the PDIC 19. Thus, a detection signal is output by the photoelectric conversion. This optical path is a return path 21B of the laser beam of the BD standard.

This concludes the description on the optical paths of the laser beam of this embodiment.

In this embodiment, the light amount of the laser beam radiated on the optical information recording medium 17 can be appropriately controlled by detecting the laser beam transmitted through the collimating lens 9 in the outward path.

Specifically, in this embodiment, the reflective mirror 10 as an element for branching the laser beam is disposed on the optical path between the collimating lens 9 and the objective lens 15. The reflective mirror 10 includes a reflective film having a polarizing property on the surface, thereby reflecting 90% of the laser beam in the outward path made incident in the +X direction in the drawing in the +Y direction and transmitting the remaining 10% of the laser beam to be radiated on the FMD 23. Thus, the laser beam converted into the parallel beam by the collimating lens 9 can be detected immediately by the FMD 23.

The FMD 23 adjusts the laser beam as follows. During the operation of the apparatus, first, the collimating lens 9 moves to optimize the spherical aberration to prevent the generation of interlayer stray beam and interlayer crosstalk. The movement of the collimating lens 9 changes the divergence angle or the convergence angle of the laser beam transmitted through the collimating lens 9, thereby changing the light amount thereof. Specifically, the light amount of the laser beam transmitted through the collimating lens 9 becomes smaller as the collimating lens 9 moves closer to the laser device (moves toward the left in the drawing), and becomes larger as the collimating lens 9 moves away from the laser device (moves toward the right in the drawing).

In this embodiment, part of the parallel beam passes through the reflective mirror 10 to be detected by the FMD 23. The FMD 23 outputs a signal corresponding to the light amount of the laser beam radiated thereon. If the output value of the FMD 23 is within a predetermined range, the light amount of laser beam emitted from the laser devices 2 and 3 remains the same. On the other hand, if the output value of the FMD 23 is not larger than a predetermined value, the light amount of the laser beam emitted from the laser devices 2 and 3 is increased. If the output value of the FMD 23 is not smaller than the predetermined value, the light amount of the laser beam emitted from the laser devices 2 and 3 is reduced. Thus, the light amount of the laser beam emitted from the laser devices 2 and 3 is controlled so that the output value of the FMD 23 is kept constant. Thus, even when the collimating lens 9 moves during the operation of the apparatus, the change in the light amount of the laser beam radiated on the optical information recording medium 17 is prevented. Accordingly, information can be read or written from or to the optical information recording medium 17 stably.

Furthermore, in this embodiment, the reflective mirror 10 and the composite prism 8 have frequency characteristics and the reflectance and the transmittance thereof are adjusted. Accordingly, there is an advantage that the optical information recording medium 17 with a low quality can be handled.

Specifically, the laser beam in the outward path is the beam linearly-polarized in the S direction (S-polarized beam), and the laser beam in the return path is the beam linearly-polarized in the P direction (P-polarized beam). This is a basic setting of general optical pickup apparatuses. Specifically, the laser beams in the outward and the return paths, respectively, are polarized in different directions so that the composite prisms 5 and 8 reflect the laser beam in the outward path but transmit the laser beam in the return path.

However, if a low quality covering layer covers the information recording layer of the optical information recording medium 17, the laser beam in the return path that is supposed to be the P-polarized beam may include an S-polarized beam component due to birefringence of the covering layer. This reduces the light amount of the returning beam reaching the PDIC 19 and makes the PDIC 19 difficult to read the signal.

This embodiment can handle such low quality optical information recording medium 17 with the following structure. The reflectance and transmittance of the reflective mirror 10 and the composite prism 8 for the P-polarized beam are adjusted to reduce the light amount of the P-polarized beam reaching the PDIC 19 and transmittance of the composite prism 8 for the S-polarized beam is secured so that a small amount of S-polarized beam component reaches the PDIC 19. Thus, the difference in the light amount of the returning beam reaching the PDIC 19 between the case where the returning beam is constituted of the P-polarized beam only (normal optical information recording medium) and the case where the returning beam includes the S-polarized beam (low-quality optical information recording medium) is reduced. Therefore, the reading accuracy of the PDIC 19 is improved. In this case, the light amount of the returning beam leaked by the reflective mirror 10 or the light amount of the laser beam on the outward path directed to the optical information recording medium 17 is set on the basis of the reduction of the reflectance of the composite prism 8 for the S-polarized beam.

This will be described with reference to FIG. 2. FIG. 2A is a diagram showing the optical paths of the laser beam of the DVD/CD standard. FIG. 2B is a diagram showing the optical paths of the laser beam of the BD standard. FIG. 2C is a chart listing the transmittance and the reflectance of the composite prisms 5 and 8, and the reflective mirror 10. In the chart of FIG. 2C, the reflectance and the transmittance for the S-polarized beam are respectively represented by Rs and Ts, whereas the reflectance and the transmittance for the P-polarized beam are respectively represented by Rp and Tp.

With reference to FIG. 2A, the outward path 20A of the optical paths of the laser beam of the DVD/CD standard is described. First, the laser beam of the DVD/CD standard as the S-polarized beam is emitted from the laser device not shown, 90% of the laser beam is reflected in the +X direction by the reflecting surface of the composite prism 8, and then is converted into parallel beam by the collimating lens 9. Then, 90% of the laser beam converted into the parallel beam is reflected in the +Y direction by the reflective mirror 10 to be radiated on an information recording medium. Meanwhile, remaining 10% of the laser beam passes through the reflective mirror 10 to be detected by the FMD 23.

Next, on the return path 20B of the laser beam (returning beam) of the DVD/CD standard reflected by the information recording medium, the quarter wavelength plate 12 shown in FIG. 1 converts the laser beam into the P-polarized beam. The reflective mirror 10 reflects 30% of the P-polarized beam in the −X direction and transmits the remaining 70% thereof in the −Y direction. Thereafter, the laser beam passes through the collimating lens 9 and 60% thereof further passes through the reflecting surface of the composite prism 8. Then, the laser beam totally passes through the reflective surface of the composite prism 5 to reach the PDIC 19. Thus, the light amount of the laser beam reaching the PDIC 19 is reduced by adjusting the reflectance of the reflective mirror 10 and the transmittance of the composite prism 8.

The outward path 21A of the laser beam of the BD standard will be described by referring to FIG. 2B. First, the laser beam emitted from the laser device not shown is totally reflected in the +X direction by the composite prism 5. Then, the laser beam totally passes through the reflecting surface of the composite prism 8 and is converted into a parallel beam by the collimating lens 9. Subsequently, 90% of the laser beam is reflected in the +Y direction by the reflective mirror 10 to be focused on a information recording layer of a BD standard information recording medium through an objecting lens and the like not shown. Meanwhile, remaining 10% of the laser beam passes through the reflective mirror 10 to be detected by the FMD 23.

The return path 21B of the returning beam of the BD standard will be described. As in the case of the laser beam of the DVD/CD standard described above, the returning beam of the BD standard is the P-polarized beam. The laser beam reflected by the information recording layer of the information recording medium is totally reflected by the reflective mirror 10, and then passes through the collimating lens 9 and the composite prisms 8 and 5 to reach the PDIC 19. The composite prisms 5 and 8 totally transmit the P-polarized beam of the BD standard. In the current situation, a BD standard optical information recording medium is almost never produced with a low quality, and thus the transmittance of the composite prism 8 is not adjusted in this case.

This embodiment has an advantage that reading and writing can be performed even on the optical information recording medium 17 with a low quality by adjusting the reflectance and the transmittance of the composite prism 8 and the reflective mirror 10 for the P-polarized beam.

The laser beam of the DVD standard, which is especially susceptible to the influence of the optical information recording medium 17, has a risk of being the S-polarized beam instead of being the P-polarized beam in the return path 20B due to the birefringence of the low quality optical information recording medium 17. In such a case, without any countermeasure, the light amount of the S-polarized beam reaching the PDIC 19 is too small to be detected easily by the PDIC 19 compared with the normal case with the P-polarized beam. As the countermeasure, the reflectance and the transmittance of the reflective mirror 10 and the composite prism 8 are adjusted in this embodiment to weaken the P-polarized returning beam.

Specifically, when the returning beam is the S-polarized beam, the percentage of the laser beam reaching the PDIC 19 is: reflectance of the reflective mirror 10 (Rs: 90%)×transmittance of the composite prism 8 (Ts: 10%)=9%. On the other hand, when the returning beam is the P-polarized beam, the percentage of the laser beam reaching the PDIC 19 through the optical elements is: reflectance of the reflective mirror 10 (Rp: 30%)×transmittance of the composite prism 8 (Tp: 60%)=18%. Thus, the percentage of the S-polarized returning beam reaching the PDIC 19 is close to that of the P-polarized returning beam reaching the PDIC 19, whereby the signal detection can be favorably performed with both types of laser beam by the light receiving surface of the single PDIC 19.

Moreover, in this embodiment, the optical paths 20 of the laser beam of the DVD/CD standard share most part with the optical paths 21 of the laser beam of the BD standard. Thus, the collimating lens 9, the reflective mirrors 10 and 11, the quarter wavelength plate 12, the PDIC 19, and the FMD 23 on the optical paths 20 and 21 are used as common elements thereon. As a result, optical system elements are disposed in the optical pickup apparatus 1 in a smaller number and can be mounted easily, and the time required for adjusting an optical axis is reduced.

Furthermore, in this embodiment, the single FMD 23 detects the laser beams of various standards. Thus, the number of parts required in the optical pickup apparatus 1 is reduced compared with a case where the FMD is provided for each laser device.

The embodiment described above can be modified as follows.

Referring to FIG. 1, in this embodiment, the laser beam transmitted through the reflective mirror 10 is detected by the FMD 23 and the laser beam reflected by the reflective mirror 10 is radiated on the optical information recording medium 17. This configuration can be modified in such a manner that, for example, the laser beam reflected by the reflective mirror 10 is detected by the FMD 23 and the laser beam transmitted through the reflective mirror 10 is radiated on the optical information recording medium 17.

Referring to the chart in FIG. 2C, the reflectance and the transmittance of the composite prism 8 for the S-polarized beam in the frequency band of a frequency of the DVD/CD standard is 90% and 10% respectively. The values may be respectively changed to 100% and 0% for example. The reflectance Rs of the composite prism 8 can be adjusted to be equal to or more than 90% and smaller than 100%. The transmittance can be adjusted to be more than 0% and smaller than 10%.

With reference to FIG. 1, in this embodiment, the amount of laser beam reaching the PDIC 19 is adjusted by adjusting the reflectance and the transmittance of the reflective mirror 10 and the composite prism 8. Instead, the reflectance and/or the transmittance of either one of the reflective mirror 10 and the composite prism 8 may be adjusted.

In a preferred embodiment of the present invention, a laser beam transmitted through a collimating lens is detected by a detecting element (FMD). Thus, the change in the light amount of the laser beam caused by the movement of the collimating lens can be accurately detected and a laser device can be controlled on the basis of the result of the detection. Thus, the amount of the laser beam radiated on an optical information recording medium due to the movement of the collimating lens is prevented from changing. Accordingly, the accuracy of reading or writing is improved.

Furthermore, in a preferred embodiment of the present invention, part of the laser beam in a return path is transmitted through a branching element (reflective mirror). Thus, a change in the light amount of the returning beam received by a photodetector is prevented from increasing even when birefringence of a cover layer covering a signal layer of the optical information recording medium changes a polarized direction of the laser beam as a returning beam reflected by the optical information recording medium.

What is claimed is:

1. An optical pickup apparatus comprising:
an emitting element that emits a laser beam;
a collimating lens that is disposed to be movable along an optical path of the laser beam and collimates the laser beam;
an objective lens that focuses the laser beam on an information recording layer of an optical information recording medium;
a branching element that is disposed on the optical path between the collimating lens and the objective lens and branches off part of the laser beam from the optical path; and
a detecting element that receives the part of the laser beam branched off from the optical path and outputs a control signal for controlling a light amount of the laser beam emitted from the emitting element.

2. The optical pickup apparatus according to claim 1, wherein the detecting element receives the laser beam branched off by the branching element on the optical path of an outward path side.

3. The optical pickup apparatus according to claim 1, wherein
the branching element is a reflective mirror,
the laser beam reflected by the reflective mirror is radiated on the optical information recording medium, and
the laser beam transmitted through the reflective mirror is received by the detecting element.

4. The optical pickup apparatus according to claim 1, wherein the branching element is disposed proximate to the collimating lens.

5. The optical pickup apparatus according to claim 1, further comprising:
a polarized beam splitting element that adjusts a transmittance depending on a polarized direction of the laser beam, receives the laser beam emitted from the emitting device and polarized in a first direction, reflects the laser beam toward the objective lens, and transmits the returning beam as the laser beam reflected by the optical information recording medium and polarized in a second direction; and
a photodetector that receives the returning beam and outputs an information signal, wherein
part of the returning light polarized in the second direction is branched off along the optical path.

6. The optical pickup apparatus according to claim 1, wherein
the laser beam includes a first laser beam with a first wavelength and a second laser beam with a second wavelength longer than the first wavelength, and
the detecting element receives the first laser beam and the second laser beam branched off and deviated from the optical path by the branching element.

7. The optical pickup apparatus according to claim 6, wherein
the first laser beam is a laser beam of a BD standard, and
the second laser beam is a laser beam of a DVD standard or a CD standard.

8. The optical pickup apparatus according to claim 5, wherein the percentage of the returning beam polarized in the second direction that the branching element branches off toward the photodetector is smaller than the percentage of the returning beam polarized in the first direction that the branching element branches off toward the photodetector.
